(19) United States
(12) Patent Application Publication
(10) Pub. No.: US 2014/0183430 A1
(43) Pub. Date: Jul. 3, 2014

(54) JACK FOR DISASTER RELIEF

(71) Applicants: Shuichi Ino, Ibaraki (JP); Mitsuru Sato, Ibaraki (JP); Shinichi Yoshimura, Osaka (JP)

(72) Inventors: Shuichi Ino, Ibaraki (JP); Mitsuru Sato, Ibaraki (JP); Shinichi Yoshimura, Osaka (JP)

(73) Assignees: NATIONAL INSTITUTE OF ADVANCE INDUSTRIAL SCIENCE AND TECHNOLOGY, Tokyo (JP); ASUKA ELECTRIC CO.LTD., Osaka (JP)

(21) Appl. No.: 14/009,700

(22) PCT Filed: Apr. 4, 2011
(86) PCT No.: PCT/JP2011/002008

§ 371 Date: Feb. 14, 2014

(51) Int. Cl. B66F 3/25

(52) U.S. Cl. CPC B66F 3/25
USPC 254/93 R

(57) ABSTRACT

A jack for disaster relief includes a hydrogen gas supply structure for heating a hydrogen absorbing alloy by means of a heat source and supplying a hydrogen gas absorbed in the hydrogen absorbing alloy, and an operation structure to be extended by a pressure of the hydrogen gas supplied from the hydrogen gas supply structure, to carry out an operation for lifting an object to be jacked up. The operation structure includes an operation base and a jack portion having an operation space sealed therein. The jack portion is configured to be extensible between a standby posture in which a pushup portion is stored and an extension posture in which the pushup portion is protruded upward from the operation base, and the whole operation structure can be held in a flat shape in a state in which the jack portion is retracted into the standby posture.

### TECHNICAL FIELD

The present invention relates to a portable jack for disaster relief which is used for rescuing victims buried under buildings collapsed by disasters such as earthquakes and typhoons, or buried alive in a collapsed ground.

### BACKGROUND ART

Referring to the jack according to the present invention, the actuator described in Patent Document 1 is well-known. According to Patent Document 1, a powdery metal hydride and a filter are disposed in an operation chamber divided by a cylinder and a piston, and the metal hydride is heated by a Peltier element to discharge a hydrogen gas absorbed in the metal hydride in the operation chamber so that a piston rod can be advanced. Moreover, a current having a reverse potential to that in the heating is supplied to the Peltier element to cool the metal hydride. Consequently, the hydrogen gas is adsorbed in the metal hydride so that the piston rod can leave/enter an inner part of the cylinder.

Patent Document 2 discloses a jack for a car which utilizes a hydrogen absorbing alloy. According to Patent Document 2, the jack is configured by a hydrogen discharge and supply body which takes a shape of a sealing container and includes the hydrogen absorbing alloy and a filter, and a fluid pressure cylinder. The hydrogen discharge and supply body and an operation chamber for the fluid pressure cylinder are connected to each other through a pressure hose, and the hydrogen discharge and supply body is heated in close contact with an external surface of a muffler of a car to discharge a hydrogen gas absorbed in the hydrogen absorbing alloy, thereby operating the fluid pressure cylinder. Thus, it is possible to carry out jack up. By removing the hydrogen discharge and supply body from the muffler of the car, moreover, it is possible to cool the hydrogen absorbing alloy, thereby absorbing the hydrogen gas to cause a piston rod of the fluid pressure cylinder to leave/enter an inner part of the cylinder.

Patent Document 3 also discloses a jack to be operated by utilizing heat of an exhaust gas of a car. According to Patent Document 3, an operation chamber is divided by a base cylinder and an up-down cylinder to be moved up and down with respect to the base cylinder, and a hydrogen absorbing alloy and a filter are disposed in the operation chamber. The base cylinder is surrounded by a gas jacket, and the exhaust gas of the car is fed to the gas jacket through a heat-resistant hose, thereby discharging a hydrogen gas absorbed in the hydrogen absorbing alloy to advance the up-down cylinder from the base cylinder. Thus, it is possible to carry out jack up.

### PRIOR ART DOCUMENTS

### Patent Documents

Patent Document 1: Japanese Patent Laid-open Publication No. Sho 61-270505 (page 2, Left and Lower Column, Lines 1 to 18, FIG. 1)
Patent Document 2: Japanese Patent Laid-open Publication No. Hei 02-095697 (page 2, Left and Lower Column, Lines 5 to 20, FIG. 1)
Patent Document 3: Japanese Patent Laid-open Publication No. Hei 04-356259 (paragraph 0007, FIG. 1)

### SUMMARY OF THE INVENTION

### Problems to be Solved by the Invention

The actuator disclosed in Patent Document 1 requires supplying a direct current in order to drive the Peltier element, and cannot be used on a site in which power supply is blocked such as an earthquake disaster site and a typhoon disaster site. Similarly, the jacks disposed in Patent Documents 2 and 3 each heat the hydrogen absorbing alloy by using the exhaust gas of the car as a heat source. For this reason, they cannot be used in the case in which a fuel of an engine is not available. At a narrow disaster site that the car cannot enter, furthermore, it is impossible to operate the jack. Moreover, a jack having a fluid pressure cylinder structure including a piston and a cylinder as components cannot be installed if there is no installation space corresponding to at least a total length of the cylinder. This is because, in a situation in which victims buried under collapsed buildings are rescued, a clearance formed under rubble to be lifted is small in many cases and it is difficult to install the jack between the rubble and the ground.

It is an object of the present invention to provide a jack for disaster relief which can be used at a disaster site where power or an engine fuel is difficult to acquire, can be carried and transported on foot, and can be installed in a small clearance formed under rubble.

### Means for Solving the Problem

A jack for disaster relief according to the present invention includes a hydrogen gas supply structure 2 for supplying a hydrogen gas absorbed in a hydrogen absorbing alloy 22 by heating the hydrogen absorbing alloy 22 using a heat source 23, and an operation structure 1 to be extended by a pressure of the hydrogen gas supplied from the hydrogen gas supply structure 2, to carry out an operation for lifting an object to be jacked up. As shown in FIG. 1, the operation structure 1 includes an operation base 3 to be mounted on an installation surface and a jack portion 5 assembled into the operation base 3 and having an operation space 4 sealed therein. The jack portion 5 is configured to be extensible between a standby posture in which a pushup portion 10 provided on an upper end thereof is stored in the vicinity of the operation base 3 and an extension posture in which the pushup portion 10 is protruded upward from the operation base. The whole operation structure 1 can be held in a flat shape in a state in which the jack portion 5 is retracted into the standby posture (see FIG. 2).

The jack portion 5 is configured to be extensible by assembling a plurality of vertically slidable extensible cylinders 6 to 9 like multistage cylinders. The hydrogen gas supplied from the hydrogen gas supply structure 2 is fed to the operation space 4, thereby switching the jack portion 5 from the standby posture to the extension posture.

As shown in FIG. 4, a bellows 33 for dividing the operation space 4 is accommodated in the jack portion 5. The bellows 33 is disposed between the extensible cylinder 9 positioned in an uppermost stage and the operation base 3.

As shown in FIGS. 5 and 6, the operation structure 1 is configured by the jack portion 5 formed by either the extensible bellows 33 or a diaphragm 34, a plate material fixed to the upper end of the jack portion 5 and forming the pushup portion 10, and the operation base 3 fixed to a lower end of the jack portion 5.

As shown in FIG. 1, the operation space 4 is provided with an extensible guide structure 15 for regulating tilt of the jack portion 5 while following an operation for extending/contracting the jack portion 5.

The operation base 3 is formed like an upward opened plate. The whole jack portion 5 retracted into the standby posture can be stored in the operation base 3 (see FIG. 2).

The hydrogen gas supply structure 2 is disposed in the operation base 3 (see FIG. 1).

A heat source of the hydrogen gas supply structure 2 is configured by one of electric heat of a heater 23 using a battery 25 as a driving source, combustion heat of a solid fuel 36, hydration heat of a quick lime 37 and combustion heat of a combustible scrap material in a disaster area.

### Advantages of the Invention

In the present invention, the jack for disaster relief is configured by the hydrogen gas supply structure 2 and the operation structure 1 to be extended by a pressure of the hydrogen gas, thereby carrying out an operation for lifting an object to be jacked up. Moreover, the operation structure 1 is configured by the operation base 3, the jack portion 5 having the operation space 4 sealed therein, and the like, and is obtained in such a manner that the jack portion 5 can be extended and contracted between the standby posture and the extension posture. Thus, the jack using the hydrogen gas as a driving medium can be operated without problems at a disaster site in which power or an engine fuel is difficult to acquire or a narrow disaster site that a car cannot enter.

Moreover, the jack using the hydrogen gas as the driving medium can output a considerably greater maximum pushup load as compared with a mechanical screw jack or a pneumatic jack. Therefore, it is possible to reliably lift a heavier object to be jacked up such as rubble at a disaster site. In a state in which the jack portion 5 is retracted into the standby posture, furthermore, the whole operation structure 1 is held in a flat shape. As compared with the conventional jack including a piston and a cylinder as components, therefore, it is possible to store the whole jack more compactly. Accordingly, it is possible to easily carry and transport the jack on foot. In addition, the whole operation structure 1 is stored in the flat shape in the standby posture. Also in a situation in which only a small clearance is formed under the rubble to be jacked up, therefore, it is possible to reliably locate the jack, thereby lifting the rubble and the like accurately. Thus, it is possible to provide a jack for disaster relief which is wholly excellent in usability.

If the plurality of extensible cylinders 6 to 9 are assembled like multistage cylinders to constitute the jack portion 5 to be extensible, it is possible to extend and contract the jack portion 5 in a positive manner between the standby posture and the extension posture by supplying the hydrogen gas to the operation space 4 in the inner part of the jack portion 5. In other words, it is possible to linearly extend and contract the jack portion 5 in a state in which a middle part of the jack portion 5 is bent or the great inclination of the whole body is eliminated. Accordingly, it is possible to accurately lift the object to be jacked up in a stable condition.

According to the jack in which the bellows 33 is accommodated in the jack portion 5 and the inner part of the bellows 33 is set to be the operation space 4, it is possible to perform an operation for extending the jack portion 5 by supplying the hydrogen gas into the bellows 33. As compared with the case in which the entirely internal space of the jack portion 5 is set to be the operation space 4, accordingly, it is possible to decrease an amount of the hydrogen gas to be fed to the operation space 4. It is possible to accurately extend the jack portion 5 while supplying the hydrogen absorbed in the hydrogen absorbing alloy 22 in a non-waste state. Moreover, the whole hydrogen gas supplied to the operation space 4 is held in the closed bellows 33. Even if the jack portion 5 is inclined in the middle of the extension, therefore, it is possible to reliably prevent the hydrogen gas from leaking out. Accordingly, it is possible to enhance reliability of the jack for disaster relief. In addition, it is not necessary to improve processing precision or sealing precision of each of the extensible cylinders 6 to 9, and furthermore, to simplify a whole structure, thereby reducing a cost required for manufacturing the jack as compared with the case in which the extensible guide structure 15 is provided.

According to the operation structure 1 obtained by the jack portion 5 formed by either the extensible bellows 33 or the diaphragm 34, the plate material constituting the pushup portion 10 and the operation base 3, it is possible to remarkably simplify the jack structure. Moreover, the extensible jack portion 5 is configured by either the bellows 33 or the diaphragm 34. As compared with the jack portion 5 having a telescopic structure, therefore, it is possible to remarkably reduce a weight of the jack. Although it is possible to output the same pushup load as that of the jack including the jack portion 5 having the telescopic structure, therefore, it is possible to obtain a simple jack which requires a lower total cost, can easily be carried and can be handled readily.

According to the jack in which the extensible guide structure 15 is provided in the operation space 4, it is possible to regulate the tilt of the jack portion 5 in the extension and contraction by means of the extensible guide structure 15. Therefore, it is possible to accurately output the pushup load of the jack portion 5 by regulating the extension of the jack portion 5 with an inclination in a variation in a load with respect to the pushup portion 10. Moreover, the extensible guide structure 15 is extended and contracted by following the extending and contracting operations of the jack portion 5. Therefore, it is possible to store the whole jack compactly in a state in which the standby posture is taken, thereby carrying and transporting the jack easily on foot and reducing a storage space.

When the hydrogen gas supply structure 2 is disposed in the operation base 3, the operation structure 1 and the hydrogen gas supply structure 2 can be integrated. As compared with the case in which the operation structure 1 and the hydrogen gas supply structure 2 are provided individually, therefore, it is possible to carry or store the jack more simply and easily. In the case in which the hydrogen gas supply structure 2 is disposed in the operation base 3 in a state in which the hydrogen gas supply structure 2 faces the operation space 4, moreover, it is possible to decrease the amount of the hydrogen gas to be supplied to the operation space 4 by the amount corresponding to a space occupied by the hydrogen gas supply structure 2 in the operation space 4, thereby utilizing the hydrogen gas effectively.

In the case in which electric heat of the heater 23 is used as the heat source of the hydrogen gas supply structure 2, it is possible to start the hydrogen absorbing alloy 22 to be heated through a simple operation for changing over a switch. Therefore, any person having no expert knowledge can also operate the jack to attend a rescue activity. According to the hydrogen gas supply structure 2 using, as a heat source, one of combustion heat of the solid fuel 36, hydration heat of the quick lime 37 and combustion heat of a combustible scrap material in a disaster area, it is possible to simplify the storage management of the jack for disaster relief. In the case in which the electric heat of the heater 23 is used as the heat source, it is necessary to prepare for a disaster while periodically confirming the charging state of the battery 25. In the case of the solid fuel 36 and the quick lime 37, however, provided that a storage state is excellent, the solid fuel 36 and the quick lime 37 can be used without problems even if a storage period is long.

### BRIEF DESCRIPTION OF THE DRAWINGS

FIG. 1 is a sectional view showing a jack for disaster relief according to a first embodiment.

FIG. 2 is a sectional view showing a state in which a jack portion is brought into a flat standby posture.

FIG. 3 is a sectional view showing a jack for disaster relief according to a second embodiment.

FIG. 4 is a sectional view showing a jack for disaster relief according to a third embodiment.

FIG. 5 is a sectional view showing a jack for disaster relief according to a fourth embodiment.

FIG. 6 is a sectional view showing a jack for disaster relief according to a fifth embodiment.

FIG. 7 is a sectional view showing a jack for disaster relief according to a sixth embodiment.

### EMBODIMENTS OF THE INVENTION

### First Embodiment

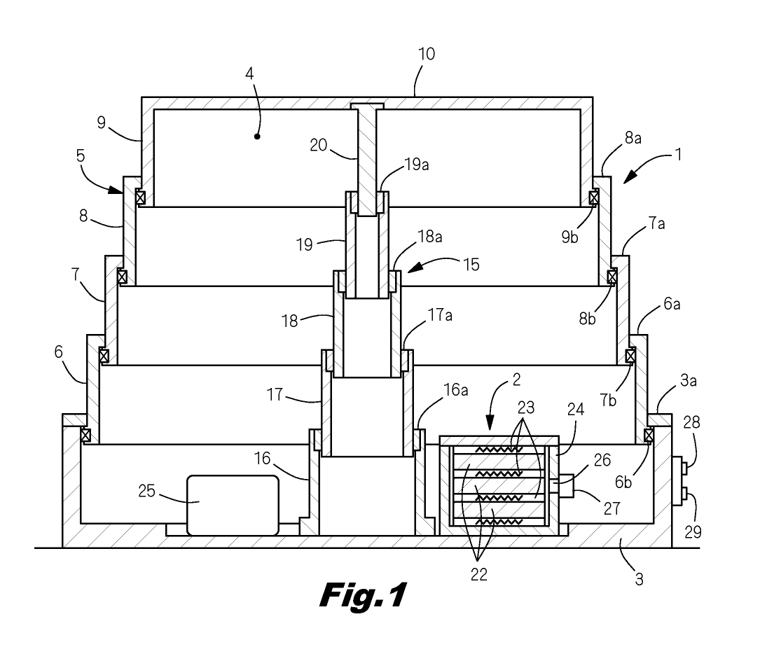

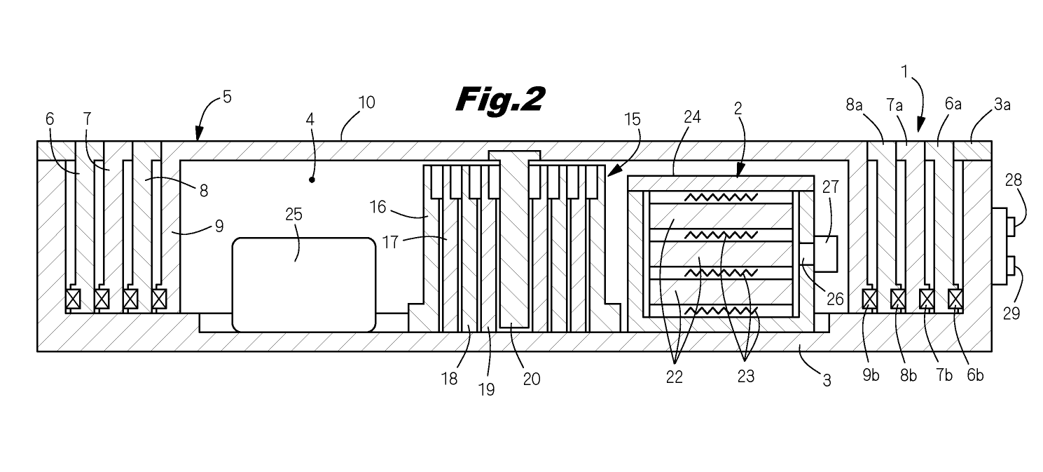

FIGS. 1 and 2 show a first embodiment of a jack for disaster relief according to the present invention. In FIG. 1, the jack for disaster relief is configured by a main structure including an operation structure 1 for carrying out an operation for lifting an object to be jacked up and a hydrogen gas supply structure 2 disposed in the operation structure 1. The operation structure 1 is configured by an operation base 3 to be mounted on an installation surface, a jack portion 5 assembled into the operation base 3 and having an operation space 4 sealed therein, and the like. The operation base 3 is provided in a shape of a round plate opened upward by a circular bottom wall and a cylindrical peripheral wall linked to a peripheral edge of the bottom wall, and is formed by a metallic material. A stopper wall 3a is protruded toward a cylindrical internal surface at an open edge of the operation base 3.

The jack portion 5 is configured to be extensible by assembling four vertical slidable metallic extensible cylinders 6 to 9 like multistage cylinders. Out of the respective extensible cylinders 6 to 9, three lower extensible cylinders 6, 7 and 8 are formed in a cylindrical shape, and stopper walls 6a, 7a and 8a are formed on inner edges of upper ends of cylindrical walls, respectively. The extensible cylinder 9 in an uppermost part is formed in a shape of a round plate which is opened downward. The operation space 4 is divided by the respective extensible cylinders 6 to 9 and the operation base 3 described above, and ring-shaped sealing members 6b, 7b, 8b and 9b for preventing leakage of a hydrogen gas are attached to peripheral surfaces of lower ends of the extensible cylinders 6 to 9. Upper surfaces of the ring-shaped walls to which the sealing members 6b, 7b, 8b and 9b are to be attached are stopped and held by the stopper walls 3a, 6a, 7a and 8a.

The extensible cylinder 6 in a lowermost part are guided and supported vertically slidably at a cylindrical internal surface of the operation base 3, and the other extensible cylinders 7, 8 and 9 are guided and supported vertically slidably at cylindrical internal surfaces of the extensible cylinders 6, 7 and 8 respectively located at lower stages of the extensible cylinders 7, 8 and 9. Consequently, the whole jack portion 5 is configured to have a telescopic structure. The respective extensible cylinders 6 to 9 can be extended and contracted between an extension posture (a posture shown in FIG. 1) in which they are slid upward and are received by the stopper walls 3a, 6a, 7a and 8a and a standby posture (shown in FIG. 2) in which the respective extensible cylinders 6 to 9 are overlapped inside and outside.

In a state in which the jack portion 5 is set into the standby posture, the respective extensible cylinders 6 to 9 can be stored in the operation base 3. At this time, the jack for disaster relief takes a shape of a flat disk and has a total height of 100 mm. The ceiling wall of the extensible cylinder 9 in the uppermost part functions as a pushup portion 10 for carrying out an operation for lifting an object to be jacked up such as rubble in a disaster area. A diameter of an internal surface of the extensible cylinder 9 in the uppermost part is set to be 250 mm, an outside diameter of the operation base 3 is set to be 300 mm, an extension/contraction stroke of the jack portion 5 is set to be approximately 32 mm, and a volume in maximum extension of the operation space 4 is set to be 19000 cc. A total weight of the jack for disaster relief is 6.6 kg and the jack portion 5 can be stored flatly in a state in which the standby posture is taken. In the case in which an attempt to reach the disaster area on foot is made, the jack can be carried and transported in an accommodating state in a backpack together with other rescue equipment such as a rope.

In order to regulate the tilt of each of the extensible cylinders 6 to 9 while following the extending and contracting operations of the jack portion 5, an extensible guide structure 15 is provided between the extensible cylinder 9 in the uppermost part and the operation base 3. The extensible guide structure 15 is configured by four guide cylinders 16 to 19 having upper and lower surfaces which are opened and a guide shaft 20 fixed to a center of an internal surface of the extensible cylinder 9 in an uppermost part. The guide cylinder 16 in a lowermost part is fixed to a center of the operation base 3.

The guide cylinders 17 to 19 extending upward are guided vertically slidably by the guide cylinders 16 to 18 respectively located at the lower stages of the guide cylinders 17 to 19, and the guide shaft 20 is guided vertically slidably by the guide cylinder 19 in the uppermost part. In order to smoothly carry out the vertical sliding operations of the guide cylinders 17 to 19 and the guide shaft 20, linear bushes 16a, 17a, 18a and 19a are fixed to internal surfaces of upper ends of the guide cylinders 16 to 19. Thus, the whole extensible guide structure 15 is formed to be the telescopic structure. Ina state in which the jack portion 5 is brought into the standby posture, the guide cylinders 17 to 19 and the guide shaft 20 can be accommodated in the guide cylinder 16 fixed to the operation base 3.

The hydrogen gas supply structure 2 is configured by a hydrogen absorbing alloy 22 and a heater (a heat source) 23, a hydrogen absorbing chamber 24 for accommodating the hydrogen absorbing alloy 22 and the heater 23 in an alternate stacking state, a battery (a secondary battery) 25, an electromagnetic valve 27 for opening/closing an entrance 26 of the hydrogen absorbing chamber 24, and the like. A push button type change-over switch is provided on a peripheral surface of the operation base 3. When a first button 28 is pressed, a current of the battery 25 is supplied to the heater 23 so that the hydrogen absorbing alloy 22 can be heated. When the pressing operation is carried out again, the supply of the current to the battery 25 is blocked so that the operation of the heater 23 can be stopped. When a second button 29 is pressed, moreover, the electromagnetic valve 27 is switched into an open condition so that an inner part of the hydrogen absorbing chamber 24 can be caused to communicate with the operation space 4. When the pressing operation is carried out again, the electromagnetic valve 27 is switched into a close condition so that the communication condition of the inner part of the hydrogen absorbing chamber 24 and the operation space 4 can be blocked.

The jack for disaster relief having the structure described above is used in a disaster area in the following manner. First of all, a mounting surface on a lower side of the object to be jacked up is made flat and the operation base 3 is thus installed thereon. At this time, if an interval between the object to be jacked up such as rubble and the mounting surface is unnecessarily great, lumber, a concrete block and the like are loaded on the mounting surface and the operation base 3 is installed in an upper surface thereof. Next, the first button 28 is pressed to operate the heater 23, and the hydrogen absorbing alloy 22 is thus heated to discharge a hydrogen gas. At the same time, the first button 29 is pressed to switch the electromagnetic valve 27 into the open condition, thereby feeding the hydrogen gas discharged into the hydrogen absorbing chamber 24 to the operation space 4 through the entrance 26 and the electromagnetic valve 27 to extend the jack portion 5.

When the hydrogen gas is fed into the operation space 4, the extensible cylinder 9 on a center is first pushed out and moved upward. When the extensible cylinder 9 is received by the stopper wall 8a of the next extensible cylinder 8, furthermore, the extensible cylinder 9 is moved upward together with the extensible cylinder 8. In the same manner, the respective extensible cylinders 8 to 6 are moved upward in order together with the extensible cylinder 9 in the uppermost part and the pushup portion 10 carries out an operation for pushing up the object to be jacked up. When the object to be jacked up is pushed up to a required height, the first button 29 is pressed to stop a conduction state to the heater 23, and at the same time, the second button 29 is pressed to switch the electromagnetic valve 27 into the close condition, thereby blocking the entrance 26. Consequently, the hydrogen gas fed into the operation space 4 is prevented from being adsorbed in the hydrogen absorbing alloy 22 so that the jack portion 5 can be continuously held in the extension posture. In this state, the object to be jacked up is supported by a strut or a concrete block to ensure safety, thereby rescuing victims pressed under rubble and the like.

A state in which the jack portion 5 is extended to a maximum extending position is detected by a sensor which is not shown, and the conduction state to the heater 23 is stopped, and at the same time, the electromagnetic valve 27 is switched into the close condition to block the entrance 26, thereby holding the jack portion 5 into the extension posture. In this state, the object to be jacked up is subjected to fall prevention measures to ensure safety, and the victims pressed under the rubble and the like are rescued. After the victims are rescued, the strut or concrete block supporting the object to be jacked up is removed and the second button 29 is then pressed to switch the electromagnetic valve 27 into the open condition, thereby causing the hydrogen absorbing chamber 24 to communicate with the operation space 4. Consequently, the hydrogen gas is adsorbed onto the hydrogen absorbing alloy 22. However, the hydrogen adsorbing reaction progresses slowly. Therefore, the jack portion 5 is not rapidly moved downward but is slowly retracted and stored in the operation base 3.

In this connection, a maximum pushup load of the jack is proportional to the product of a pressure receiving area of the extensible cylinder 9 in the uppermost stage and a pressure of the hydrogen gas fed into the operation space 4. For example, in the case in which the operation space 4 in a nonuse state is approximately 1 atm, the pushup portion 10 of the extensible cylinder 9 can exert a pushup force of approximately 0.52 t when the hydrogen gas is supplied to raise the atmospheric pressure of the operation space 4 to be 2 atm. When the atmospheric pressure of the operation space 4 is raised to be 4 atm, moreover, the pushup portion 10 of the extensible cylinder 9 can exert a pushup force of approximately 1.5 t. Thus, the jack using the hydrogen gas as a driving medium can output a considerably greater maximum pushup load as compared with a mechanical screw jack or a pneumatic jack. Therefore, it is possible to reliably lift a heavier object to be jacked up at a disaster site, thereby contributing to the disaster relief.

As the hydrogen absorbing alloy 22, it is possible to apply a La—Ni system, a Ca—Ni₅ system, a Mm—Ni system, a Ti—Fe system or the like. In the Mm—Ni system, Mm is an alloy containing a plurality of rare earths obtained by a rare earth generation process. In the case in which the La—Ni based hydrogen absorbing alloy 22 is used and the diameter of the internal surface of the extensible cylinder 9 in the uppermost part is set to be 250 mm, a weight of the hydrogen absorbing alloy 22 required for raising the atmospheric pressure of the operation space 4 by 1 atm is approximately 130 g.

As a matter of course, it is possible to use the jack for disaster relief having the structure described above at a disaster site where power or an engine fuel is difficult to acquire. In addition, the object to be jacked up such as rubble having a great weight can be pushed up to rescue victims pressed under the rubble and the like. Moreover, the whole jack having a small total weight and taking the standby posture can be held in a flat shape. Therefore, it is possible to easily carry and transport the jack on foot, and to reliably bring the jack into a disaster site that a car cannot enter. Also in a situation in which a clearance formed under the rubble is small, furthermore, it is possible to install the jack without hindrance usefully for the disaster relief. By simply carrying out the operation for switching the first and second buttons 28 and 29, it is possible to push up the object to be jacked up such as the rubble. When there is a shortage of people who engage in the rescue work, therefore, ordinary people having no expert knowledge can operate the jack, thereby carrying out the rescue work.

### Second Embodiment

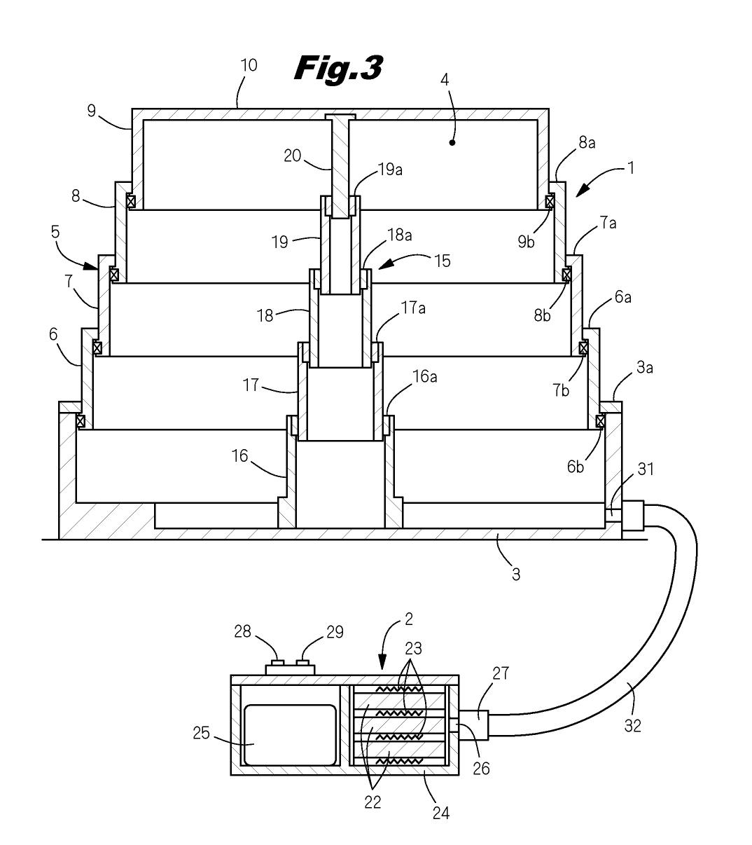

FIG. 3 shows a second embodiment of the jack for disaster relief according to the present invention. According to the second embodiment, a hydrogen gas supply structure 2 is provided separately from an operation structure 1, and a connecting port 31 provided on an operation base 3 and an electromagnetic valve 27 are caused to communicate with each other through a gas passage 32. Moreover, an inner part of a hydrogen absorbing chamber 24 is divided into two chambers, and a battery 25 is disposed in one of them and a hydrogen absorbing alloy 22 and a heater 23 are accommodated in the other. A change-over switch is disposed on an upper surface of a cover for sealing an open surface of the hydrogen absorbing chamber 24. Since the other structures are the same as those of the previous embodiment, the same members have the same reference numerals and description thereof will be omitted. The following embodiments will also be identical.

### Third Embodiment

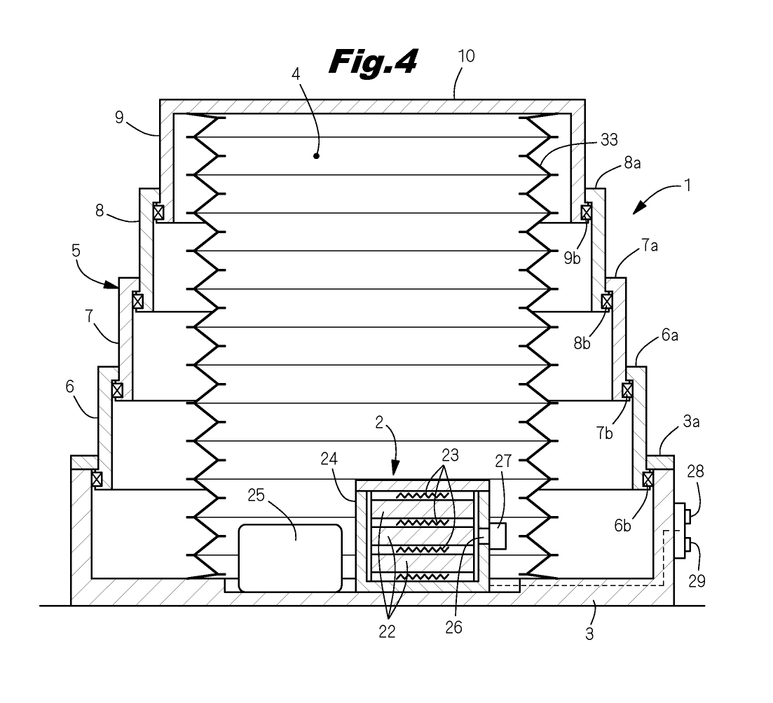

FIG. 4 shows a third embodiment of the jack for disaster relief according to the present invention. According to the third embodiment, a bellows 33 is accommodated in a jack portion 5, and an operation space 4 is formed in the bellows 33. Moreover, a hydrogen gas supply structure 2 is disposed in the operation space 4 divided by the bellows 33. The bellows 33 is formed in an accordion shape by a laminate film having high hydrogen airtightness or a polymeric material, and has an upper end fixed to an internal surface of a pushup portion 10 of an extensible cylinder 9 positioned in an uppermost stage and a lower end fixed to an inner bottom wall of an operation base 3.

In the jacks described in the first and second embodiments, there is a fear that the respective extensible cylinders 6 to 9 might be tilted and extended due to a deviation of a load with respect to the pushup portion 10. In that case, there is a fear that the sealing members 6a to 9a might cause a sealing failure, resulting in leakage of the hydrogen gas in the operation space 4 to an outside. By constituting the jack portion 5 by the extensible cylinders 6 to 9 taking the shape of multistage cylinders and the bellows 33 as described above, however, it is possible to reliably prevent the hydrogen gas from leaking out of the operation space 4 of the bellows 33 even if the respective sealing members 6a to 9a cause the sealing failure. Moreover, the extensible guide structure 15 according to the previous embodiments can be omitted, and furthermore, it is not necessary to enhance processing precision or sealing precision of each of the extensible cylinders 6 to 9. Therefore, it is possible to reduce a cost required for manufacturing the jack as a whole.

### Fourth Embodiment

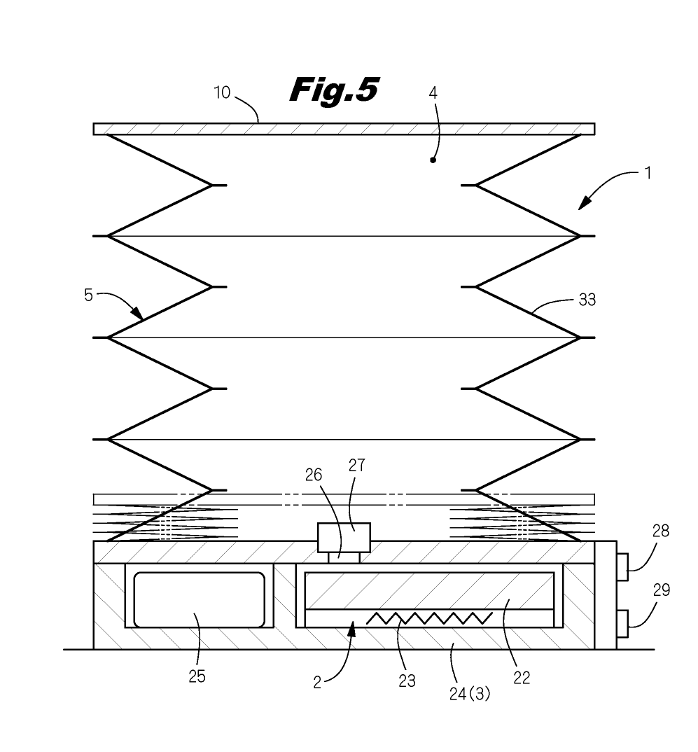

FIG. 5 shows a fourth embodiment of the jack for disaster relief according to the present invention. According to the fourth embodiment, a jack portion 5 is configured by a bellows 33, and a plate material is fixed to an upper end of the bellows 33 to form a pushup portion 10. Moreover, a lower end of the bellows 33 is fixed to a cover for sealing an open surface of a hydrogen absorbing chamber 24, and an entrance 26 and an electromagnetic valve 27 are disposed on a cover facing an operation space 4 in the bellows 33. In the present embodiment, the hydrogen absorbing chamber 24 is also used as an operation base 3, and the whole bellows 33 is folded up and the pushup portion 10 provided on the upper end of the bellows 33 is stored in the vicinity of the operation base 3 in a state in which the jack portion 5 is brought into a standby posture.

### Fifth Embodiment

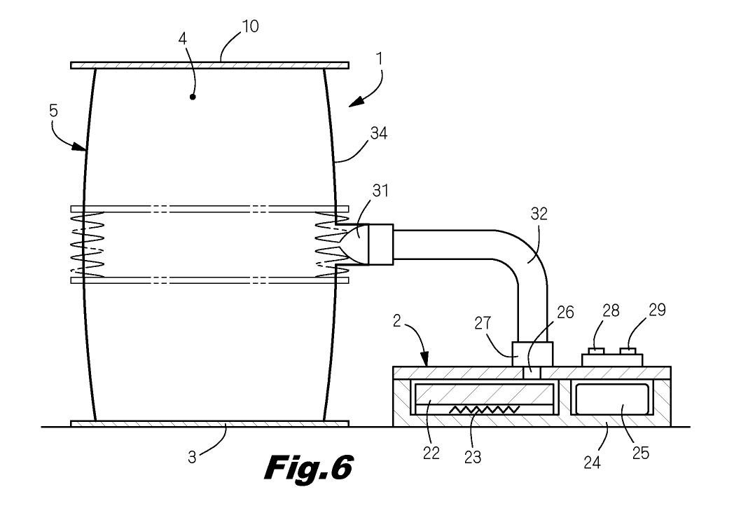

FIG. 6 shows a fifth embodiment of the jack for disaster relief according to the present invention. According to the fifth embodiment, a jack portion 5 is configured by a diaphragm 34, and a plate material is fixed to an upper end of the diaphragm 34 to form a pushup portion 10. Moreover, a plate material is fixed to a lower end of the diaphragm 34 to form an operation base 3. A hydrogen gas supply structure 2 is provided separately from an operation structure 1, and an electromagnetic valve 27 and a connecting port 31 provided on the operation base 3 are caused to communicate with each other through a gas passage 32. The diaphragm 34 is formed by a laminate film having high hydrogen airtightness or a polymeric material.

### Sixth Embodiment

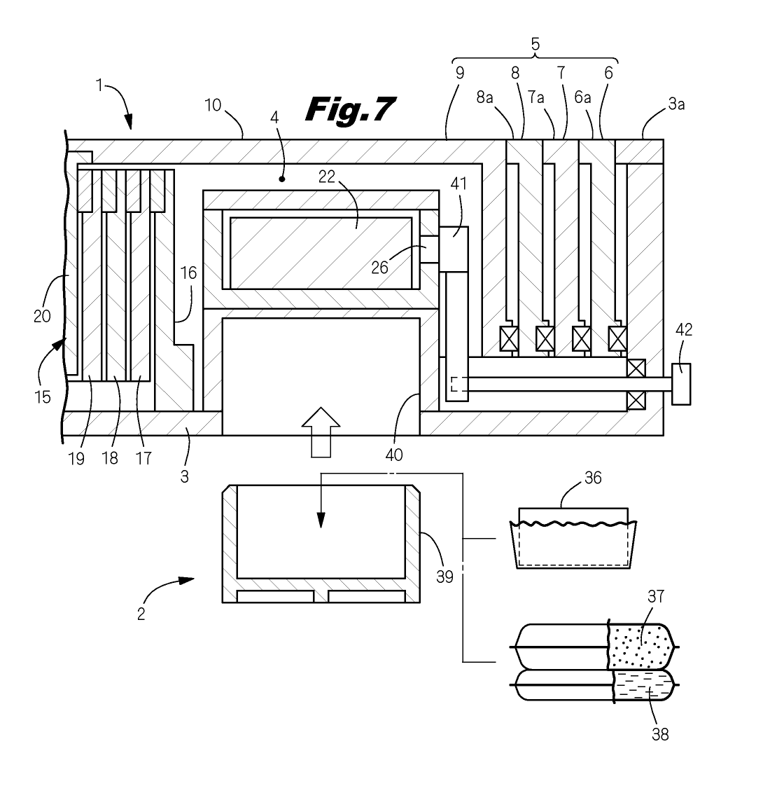

FIG. 7 shows a sixth embodiment of the jack for disaster relief according to the present invention. According to the sixth embodiment, as a heat source of a hydrogen gas supply structure 2, it is possible to utilize either combustion heat of a solid fuel (a heat source) 36 or hydration heat of a quick lime (a heat source) 37 and water 38. For this purpose, a heating container 39 for accommodating the solid fuel 36 or the quick lime 37 and the water 38 is provided, and a concave portion 40 for loading the heating container 39 is formed in an upward concave shape on a lower surface at a center of an operation base 3. Moreover, a switching valve 41 provided on an entrance 26 is changed over between an open condition and a close condition by means of an operation rod 42 which can be pushed and pulled. The quick lime 37 and the water 38 are accommodated in the heating container 39 in a state in which they are taken out of packaging bags. The combustion heat of the solid fuel 36 and the hydration heat of the quick lime 37 and the water 38 are conducted to a hydrogen absorbing alloy 22 through a ceiling wall of the concave portion 40.

In addition to the embodiments described above, it is possible to apply a pantograph structure as the extensible guide structure 15. If necessary, it is possible to add the extensible guide structure 15 into the operation chamber 4 of the jack described with reference to FIGS. 4 to 6. It is possible to apply an air bag formed by a laminate film having high hydrogen airtightness or a polymeric material in place of the bellows 33 and the diaphragm 34.

The jack portion 5 can be configured by at least two extensible cylinders. The hydrogen gas supplied from the operation space 4 does not need to be adsorbed in the hydrogen absorbing alloy 22 again but can be discharged into the air, thereby retracting the jack portion 5. The change-over switch does not need to have the structures described in the embodiments but it is sufficient to employ any change-over switch capable of controlling a conduction state to the heater 23 and the electromagnetic valve 27.

### DESCRIPTION OF REFERENCE SIGNS

1: Operation structure
2: Hydrogen gas supply structure
3: Operation base
4: Operation space
5: Jack portion
6 to 9: Extensible cylinder
10: Pushup portion
15: Extensible guide structure
22: Hydrogen absorbing alloy
23: Heater (heat source)
24: Hydrogen absorbing chamber
25: Battery
26: Entrance
27: Electromagnetic valve
33: Bellows

1. A jack for disaster relief comprising:
a hydrogen gas supply structure for heating a hydrogen absorbing alloy by means of a heat source and supplying a hydrogen gas absorbed in the hydrogen absorbing alloy; and
an operation structure to be extended by a pressure of the hydrogen gas supplied from the hydrogen gas supply structure, to carry out an operation for lifting an object to be jacked up,
wherein the operation structure includes an operation base to be mounted on an installation surface and a jack portion assembled into the operation base and having an operation space sealed therein,
the jack portion is configured to be extensible between a standby posture in which a pushup portion provided on an upper end thereof is stored in the vicinity of the operation base and an extension posture in which the pushup portion is protruded upward from the operation base, and
the whole operation structure can be held in a flat shape in a state in which the jack portion is retracted into the standby posture.

2. The jack for disaster relief according to claim 1, wherein
the jack portion is configured to be extensible by assembling a plurality of vertically slidable extensible cylinders like multistage cylinders, and
the hydrogen gas supplied from the hydrogen gas supply structure is fed to the operation space, thereby capable of switching the jack portion from the standby posture to the extension posture.

3. The jack for disaster relief according to claim 2, wherein
a bellows for dividing the operation space is accommodated in the jack portion, and
the bellows is disposed between the extensible cylinder positioned in an uppermost stage and the operation base.

4. The jack for disaster relief according to claim 1, wherein
the operation structure is configured by the jack portion formed by either the extensible bellows or a diaphragm, a plate material fixed to the upper end of the jack portion and forming the pushup portion, and the operation base fixed to a lower end of the jack portion.

5. The jack for disaster relief according to claim 2, wherein
the operation space is provided with an extensible guide structure for regulating tilt of the jack portion while following an operation for extending/contracting the jack portion.

6. The jack for disaster relief according to claim 1, wherein
the operation base is formed like an upward opened plate, and
the whole jack portion retracted into the standby posture can be stored in the operation base.

7. The jack for disaster relief according to claim 1, wherein
the hydrogen gas supply structure is disposed in the operation base.

8. The jack for disaster relief according to claim 1, wherein
a heat source of the hydrogen gas supply structure is configured by one of electric heat of a heater using a battery as a driving source, combustion heat of a solid fuel, hydration heat of a quick lime and combustion heat of a combustible scrap material in a disaster area.
